(19) United States
(12) Patent Application Publication
(10) Pub. No.: US 2023/0328708 A1
(43) Pub. Date: Oct. 12, 2023

(54) RADIO COMMUNICATION CONTROL DEVICE AND RADIO COMMUNICATION CONTROL METHOD

(71) Applicant: Fujitsu Limited, Kawasaki-shi (JP)

(72) Inventor: Shunsuke FUJIO, Kawasaki (JP)

(73) Assignee: Fujitsu Limited, Kawasaki-shi (JP)

(21) Appl. No.: 18/086,745

(22) Filed: Dec. 22, 2022

(30) Foreign Application Priority Data
Apr. 6, 2022 (JP) 2022-063255

(51) Int. Cl. H04W 72/044; H04B 7/06; H04W 72/54

(52) U.S. Cl. CPC H04W 72/046; H04B 7/0697; H04W 72/54

(57) ABSTRACT

A processor of radio communication control device estimates beams provided by communication device that supports spatial multiplexing. The processor estimate, for each user terminal, received power of a signal from corresponding user terminal by using target beam associated with target user terminal. The processor determines selection probability indicating a probability that the target user terminal is selected and simultaneous selection probability indicating a probability that the other user terminal is selected when the target user terminal is selected based on selection policy. The processor estimates average interference power for a signal transmitted from the target user terminal and simultaneous selection probability of each of the other user terminal. The processor estimates average transmission rate between the communication device and the target user terminal based on the received power, the average interference power, and the selection probability of the target user terminal.

### CROSS-REFERENCE TO RELATED APPLICATION

This application is based upon and claims the benefit of priority of the prior Japanese Patent Application No. 2022-063255, filed on Apr. 6, 2022, the entire contents of which are incorporated herein by reference.

### FIELD

The embodiments discussed herein are related to a device and a method for estimating a transmission rate of radio communication.

### BACKGROUND

As one of techniques for implementing wide-band and large-capacity radio communication, a communication method using a millimeter wave or a terahertz wave has been developed. However, communication using a millimeter wave or a terahertz wave involves a large propagation loss and a large loss due to shielding. Thus, in order to improve communication quality, a radio communication system including a movable relay device has been proposed. The movable relay device is disposed, for example, at a position where the transmission rate of the radio communication system is high. In the following description, it is assumed that the movable relay device includes a movable base station. Further, a movable relay device (including a movable base station) may be referred to as a “relay station” or a “communication device”.

The relay station is implemented in, for example, an un-manned aerial vehicle (UAV) or a vehicle and relays communication between a base station and a user terminal. A position of the relay station is controlled by, for example, the base station. Accordingly, the base station can dispose the relay station in, for example, an area with a poor radio wave environment or an area where many user terminals operate. Consequently, a sufficient radio coverage area can be secured.

On the other hand, spatial multiplexing has been put into practical use as one of techniques for improving a transmission rate. Spatial multiplexing is implemented by forming a plurality of transmission/reception beams by a multi-input multi-output (MIMO) technology. The base station or the relay station can simultaneously communicate with a plurality of user terminals by spatial multiplexing.

A method for improving a total throughput in a radio communication system including a plurality of base stations has been proposed (for example, Japanese Laid-open Patent Publication No. 2010-193288 A). In addition, a method of reducing the number of beams to be used for communication with a radio terminal has been proposed (for example, Japanese Laid-open Patent Publication No. 2016-167776 A).

The relay station is preferably disposed at a position where an average transmission rate or a total transmission rate of the radio communication system becomes high. Thus, in a procedure of determining the position of the relay station, the transmission rate at a destination of the relay station is estimated. For example, the transmission rate is estimated for each of a plurality of candidates for the destination. Then, the relay station is disposed at the destination where the estimated transmission rate is the highest.

Here, when the relay station supports spatial multiplexing, the relay station can simultaneously communicate with a plurality of user terminals. Thus, in this case, an average transmission rate (or a total transmission rate) of one or more user terminals connected to the relay station is calculated. However, at the time of estimating the transmission rate, which a user terminal is selected by the relay station is not determined. Thus, the average transmission rate of the radio communication system can be obtained by estimating the transmission rate for each selection pattern of the user terminal and calculating the average thereof.

In order to obtain an average transmission rate with high accuracy by this method, it is preferable to estimate the transmission rate for many selection patterns. However, a calculation amount for estimating the transmission rate is large. For this reason, if the number of selection patterns is increased, the calculation amount for estimating the transmission rate becomes enormous. Note that, if the number of selection patterns is reduced, estimation accuracy of the transmission rate is lowered, so that the relay station cannot be disposed at an appropriate position, and communication performance may be deteriorated.

### SUMMARY

According to an aspect of the embodiments, a radio communication control device includes a processor that executes instructions to estimate beams that are respectively associated with a plurality of user terminals located in a cell of a communication device that supports spatial multiplexing; estimate, for each of the plurality of user terminals, received power of a signal received by the communication device from a corresponding user terminal by using a target beam associated with a target user terminal among the plurality of user terminals; determine a selection probability indicating a probability that the target user terminal is selected and a simultaneous selection probability indicating a probability that each of the other user terminal among the plurality of user terminals is selected when the target user terminal is selected based on a selection policy determined in advance for selecting a user terminal in the spatial multiplexing; estimate average interference power for a signal transmitted from the target user terminal based on received power corresponding to each of the other user terminal and a simultaneous selection probability of each of the other user terminal; and estimate an average transmission rate between the communication device and the target user terminal based on received power corresponding to the target user terminal, the average interference power, and the selection probability of the target user terminal.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 illustrates an example of a radio communication system according to an embodiment of the present disclosure;

FIGS. 2A to 2C illustrate an example of a method for calculating a transmission rate;

FIGS. 3A to 3C illustrate outline of a transmission rate estimation method according to the embodiment of the present disclosure;

FIG. 4 illustrates an example of a radio communication control device according to the embodiment of the present disclosure;

FIG. 5 is a flowchart illustrating an example of a process of the radio communication control device;

FIG. 6 illustrates an example of a method for estimating a beam associated with a user terminal;

FIG. 7 illustrates an example of a method for estimating received power;

FIGS. 8A and 8B illustrate an example of a method for determining a selection probability of a user terminal;

FIGS. 9A and 9B illustrate an example of a method for determining a probability that another user terminal is simultaneously selected when a target user terminal is selected;

FIG. 10 is a flowchart illustrating an example of a process of estimating an average transmission rate; and

FIG. 11 illustrates a result of simulation relating to a comparison between the embodiment of the present disclosure and an all-pattern selection method.

### DESCRIPTION OF EMBODIMENTS

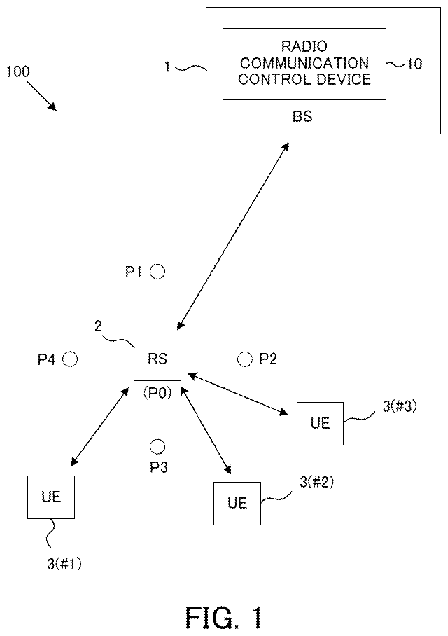

FIG. 1 illustrates an example of a radio communication system according to an embodiment of the present disclosure. In this example, a radio communication system 100 includes a base station (BS) 1, a relay station (RS) 2, and a user terminal (UE) 3. Note that the radio communication system 100 may include a plurality of relay stations 2 and/or a plurality of user terminals 3.

The base station 1 can accommodate one or more user terminals 3. The base station 1 can accommodate one or more relay stations 2. Note that the base station 1 is not particularly limited but is, for example, an eNodeB supporting 4G or a gNodeB (an NR base station) supporting 5G. The relay station 2 relays communication between the base station 1 and the user terminal 3. The relay station 2 can move. For example, the relay station 2 is provided on a UAV (so-called drone). A position of the relay station 2 is controlled by the base station 1. In other words, the base station 1 includes a radio communication control device 10 that controls the position of the relay station 2. Accordingly, the base station 1 can dispose the relay station 2 in, for example, an area with a poor radio wave environment or an area where many user terminals 3 operate. Consequently, a sufficient radio coverage area is secured. Note that the base station 1 may control a direction of transmission/reception beams of the relay station 2.

The base station 1 and the relay station 2 respectively periodically output reference signals. Transmission power of the reference signal is determined in advance. The user terminal 3 measures received power (reference signal received power (RSRP)) of the reference signals transmitted from the base station 1 and the relay station 2. The base station 1 is notified of a measurement result of the RSRP. Then, whether the user terminal 3 will be connected to the base station 1 or the relay station 2 is determined based on the measurement result. In the following description, it is assumed that the user terminal 3 is connected to the relay station 2.

The radio communication control device 10 controls the position of the relay station 2. Specifically, the radio communication control device 10 determines the position of the relay station 2 so as to increase a transmission rate between the relay station 2 and the user terminal 3. Then, the radio communication control device 10 moves the relay station 2 to the determined position. As a result, an average transmission rate or a total transmission rate of the radio communication system 100 increases.

In this embodiment, the relay station 2 is disposed at a position P0. P1 to P4 represent candidates for a destination of the relay station 2. P1, P2, P3, and P4 represent, for example, positions moved by a specified distance from the position P0 toward north, east, south, and west. The radio communication control device 10 respectively estimates transmission rates when the relay station 2 moves to the positions P1 to P4. The transmission rate represents an average value or a sum of transmission rates between the relay station 2 and the user terminal 3 (#1 to #3). Then, the radio communication control device 10 moves the relay station 2 to a position at which the highest transmission rate can be obtained among the positions P1 to P4. When the transmission rate estimated for each of the positions P1 to P4 is lower than the transmission rate obtained at the current position P0, it is not necessary to move the relay station 2.

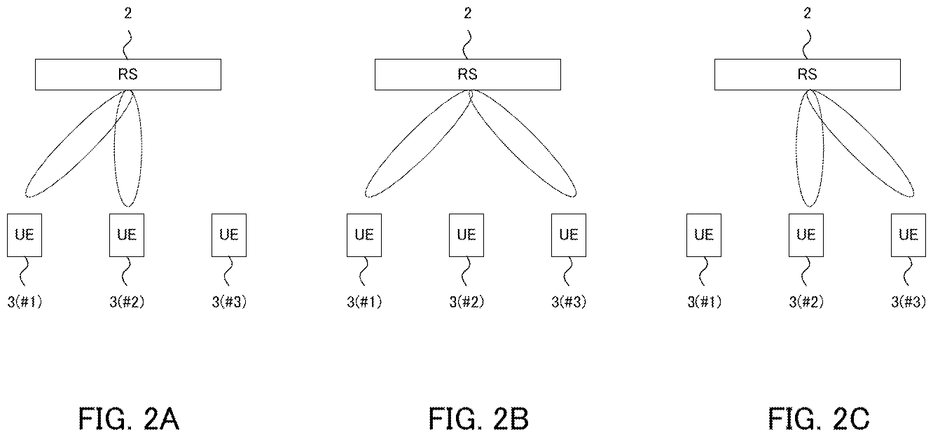

FIGS. 2A to 2C illustrate an example of a method for calculating a transmission rate. The relay station 2 supports spatial multiplexing. In this example, the multiplexing capability is “2”. In other words, the relay station 2 can simultaneously communicate with two user terminals 3. In addition, three user terminals 3 (#1 to #3) are located in a cell of the relay station 2. Thus, the relay station 2 selects two user terminals 3 from the three user terminals 3 and performs communication. Note that, in the following description, the user terminal 3 (#i) may be referred to as “UE #i”.

In the case illustrated in FIG. 2A, the relay station 2 communicates with UE #1 and UE #2. In this case, the radio communication control device 10 estimates a transmission rate R1 between the relay station 2 and the UE #1 and a transmission rate R2 between the relay station 2 and the UE #2. Then, by calculating an average of the transmission rates R1 and R2, the transmission rate when the relay station 2 communicates with the UE #1 and the UE #2 is obtained.

Similarly, in the case illustrated in FIG. 2B, a transmission rate when the relay station 2 communicates with the UE #1 and UE #3 is estimated. In the case illustrated in FIG. 2C, a transmission rate when the relay station 2 communicates with the UE #2 and the UE #3 is estimated. Then, an average transmission rate in one candidate for the destination is obtained by calculating an average of the transmission rates obtained in the three cases illustrated in FIGS. 2A to 2C. Note that, in the radio communication system 100 illustrated in FIG. 1, this calculation is performed for each of the positions P1 to P4.

As described above, in the methods illustrated in FIGS. 2A to 2C, the transmission rates are estimated for all the selection patterns of the relay station 2 and the user terminal 3, and the average thereof is calculated. Thus, in a case where the multiplexing capability of the relay station 2 is large and/or in a case where many user terminals 3 are located in the cell of the relay station 2, a calculation amount for calculating the average transmission rate becomes enormous. For example, in a case where the multiplexing capability of the relay station 2 is 4 and ten user terminals 3 are located in the cell of the relay station 2, there are 210 selection patterns (that is, the number of combinations for selecting 4 terminals from 10 terminals). Then, transmission rate estimation corresponding to each selection pattern is performed for each terminal. Thus, 840 patterns of transmission rate estimation are required.

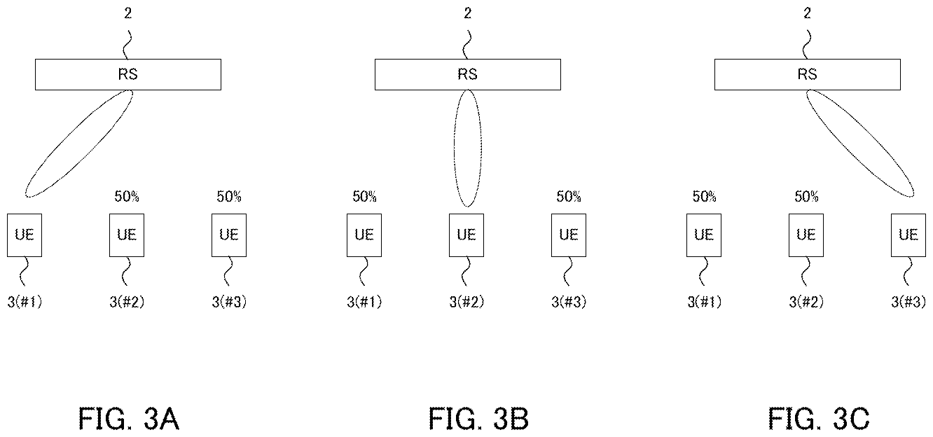

FIGS. 3A to 3C illustrate an outline of a transmission rate estimation method according to the embodiment of the present disclosure. Also in this example, the multiplexing capability of the relay station 2 is “2”. In addition, three user terminals 3 (#1 to #3) are located in a cell of the relay station 2.

In the method according to the embodiment of the present disclosure, the radio communication control device 10 calculates a transmission rate for each user terminal 3. In this event, the radio communication control device 10 determines a selection probability of each user terminal and a probability that another user terminal is simultaneously selected when a certain user terminal is selected based on a selection policy prepared in advance. Then, the radio communication control device 10 estimates a transmission rate in consideration of these probabilities.

The relay station 2 can simultaneously communicate with two user terminals 3. Thus, in the estimation of the transmission rate, two user terminals are selected from the UE #1 to the UE #3 located in the cell of the relay station 2.

In the case illustrated in FIG. 3A, the UE #1 is selected. In addition, a probability that each user terminal other than the UE #1 is selected when the UE #1 is selected is determined based on a specified selection policy. In this example, the selection policy is “fair” or “equal”. In other words, probabilities that the respective user terminals (UE #2 to UE #3) other than the UE #1 are selected are the same. Specifically, a probability that the UE #2 is selected is 50%, and a probability that the UE #3 is selected is also 50%.

The radio communication control device 10 estimates a transmission rate between the relay station 2 and the UE #1. This transmission rate depends on interference power caused by signals transmitted from other user terminals (UE #2, UE #3). However, probabilities that the UE #2 and the UE #3 are selected when the UE #1 is selected are 50%. Thus, when the transmission rate of the UE #1 is calculated, the radio communication control device 10 multiplies each of the interference power caused by the signals transmitted from the UE #2 and the UE #3 by “0.5”. As a result, a transmission rate in consideration of the probability that the other user terminal is selected can be obtained. Further, the radio communication control device 10 multiplies the transmission rate by the probability of selecting the UE #1 (in this example, 100%). As a result, a transmission rate between the relay station 2 and the UE #1 is obtained.

In the case illustrated in FIG. 3B, the UE #2 is selected. In this case, according to the selection policy described above, a probability that the UE #1 is selected is 50%, and a probability that the UE #3 is selected is also 50%. Thus, when the transmission rate of the UE #2 is calculated, the radio communication control device 10 multiplies each of the interference power caused by the signals transmitted from the UE #1 and the UE #3 by “0.5”. Further, the radio communication control device 10 multiplies the transmission rate by a probability (in this example, 100%) that the UE #2 is selected. As a result, a transmission rate between the relay station 2 and the UE #2 is obtained.

In the case illustrated in FIG. 3C, the UE #3 is selected. In this case, according to the selection policy described above, a probability that the UE #1 is selected is 50%, and a probability that the UE #2 is selected is also 50%. Thus, when the transmission rate of the UE #3 is calculated, the radio communication control device 10 multiplies each of the interference power caused by the signals transmitted from the UE #1 and the UE #2 by “0.5”. Further, the radio communication control device 10 multiplies the transmission rate by a probability (in this example, 100%) that the UE #3 is selected. As a result, a transmission rate between the relay station 2 and the UE #3 is obtained.

Thereafter, the radio communication control device 10 calculates an average transmission rate by calculating an average of the estimated transmission rates of the user terminal (UE #1 to UE #3). As described above, in the method according to the embodiment of the present disclosure, the radio communication control device 10 estimates the transmission rate for each user terminal 3 and calculates the average thereof to obtain the average transmission rate. In other words, the average transmission rate can be obtained by the same number of times of calculation as the number of user terminals 3 located in the cell of the relay station 2. Thus, compared with the methods illustrated in FIGS. 2A to 2C, a calculation amount for calculating an average transmission rate is greatly reduced. For example, when ten user terminals 3 are located in the cell of the relay station 2, the average transmission rate of the relay station 2 can be obtained by estimating the transmission rate for each of ten selection patterns regardless of the multiplexing capability of the relay station 2.

In estimating the transmission rate, the transmission/reception beam may be formed in consideration of only a weight for the target user terminal. In addition, it is preferable to multiply the estimated interference power by a coefficient corresponding to the interference suppression performance of the relay station 2.

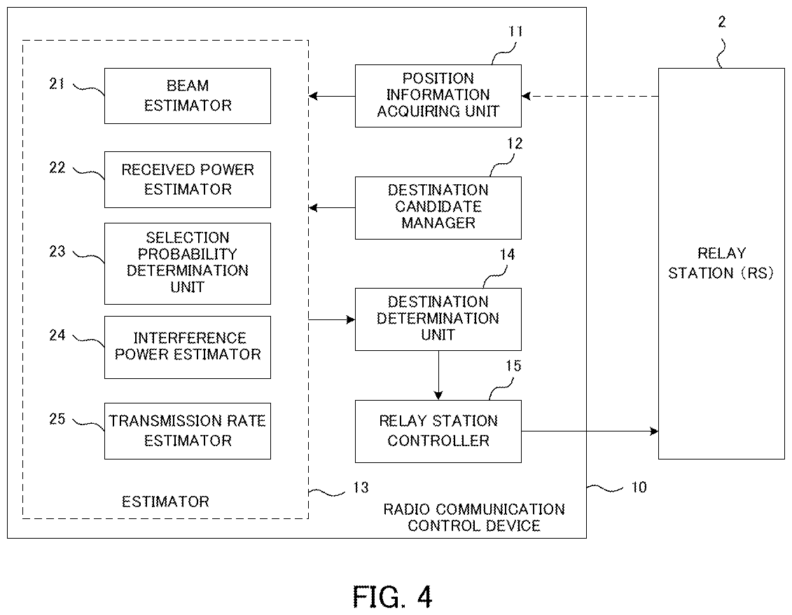

FIG. 4 illustrates an example of the radio communication control device 10 according to the embodiment of the present disclosure. The radio communication control device 10 is provided in the base station 1, for example, as illustrated in FIG. 1. However, the embodiment of the present disclosure is not limited to this configuration. In other words, the radio communication control device 10 may be provided independently of the base station 1.

The radio communication control device 10 includes a position information acquiring unit 11, a destination candidate manager 12, an estimator 13, a destination determination unit 14, and a relay station controller 15. Note that the radio communication control device 10 may include other functions or circuits not illustrated in FIG. 4.

The position information acquiring unit 11 acquires position information indicating a position of each user terminal 3 in the cell of the relay station 2. The position of each user terminal 3 may be detected using, for example, a global positioning system (GPS). Further, the position information acquiring unit 11 may acquire position information indicating the position of the relay station 2. However, in this embodiment, the position of the relay station 2 is controlled by the radio communication control device 10. Thus, the position information acquiring unit 11 does not have to acquire the position information of the relay station 2.

The destination candidate manager 12 manages candidates for the destination of the relay station 2. For example, in the case illustrated in FIG. 1, when a current position of the relay station 2 is P0, P1 to P4 are prepared as the candidates for the destination. P1, P2, P3, and P4 represent, for example, positions moved by a specified distance from the position P0 toward north, east, south, and west.

The estimator 13 estimates an average transmission rate between the relay station 2 and the user terminal 3 for each candidate for the destination prepared by the destination candidate manager 12. A method for estimating the average transmission rate will be described later in detail.

The destination determination unit 14 determines the destination of the relay station 2 based on the average transmission rate estimated by the estimator 13. Specifically, the destination determination unit 14 selects the candidate for the destination having the highest average transmission rate from the candidates for the destination prepared by the destination candidate manager 12 as the destination of the relay station 2.

The relay station controller 15 generates an instruction to move the relay station 2 to the destination determined by the destination determination unit 14. For example, when the relay station 2 is provided on the UAV, the relay station controller 15 gives a movement instruction to the UAV. As a result, the relay station 2 is disposed at a position where the transmission rate is expected to be high. This results in improving performance of the radio communication system. Note that the relay station controller 15 is an example of a position controller that controls a position of the communication device.

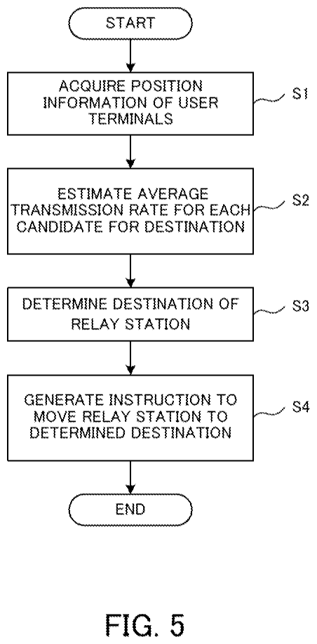

FIG. 5 is a flowchart illustrating an example of a process of the radio communication control device 10. The process of this flowchart is executed periodically, for example. In this case, the radio communication control device 10 may execute the process of this flowchart at intervals of several seconds.

In S1, the position information acquiring unit 11 acquires position information indicating a position of each user terminal 3. In S2, the estimator 13 estimates the average transmission rate between the relay station 2 and the user terminals 3 for each candidate for the destination of the relay station 2. In S3, the destination determination unit 14 determines the destination of the relay station 2 by selecting a candidate for the destination having the highest average transmission rate. In S4, the relay station controller 15 generates an instruction to move the relay station 2 to the destination determined in S3. This movement instruction is transmitted to the relay station 2 or a mobile object (for example, the UAV) on which the relay station 2 is provided. As a result, the relay station 2 is disposed at a position where the transmission rate is high.

Next, a method for estimating the average transmission rate between the relay station 2 and the user terminals 3 will be described. The average transmission rate between the relay station 2 and the user terminals 3 is estimated by the estimator 13 illustrated in FIG. 4.

As illustrated in FIG. 4, the estimator 13 includes a beam estimator 21, a received power estimator 22, a selection probability determination unit 23, an interference power estimator 24, and a transmission rate estimator 25. Note that the estimator 13 may have other functions not illustrated in FIG. 4.

The beam estimator 21 estimates a beam associated with each user terminal 3 by the relay station 2 based on the position of the relay station 2 and the position of each user terminal 3. Here, it is assumed that the relay station 2 selects one or a plurality of beams from a plurality of beams determined in advance.

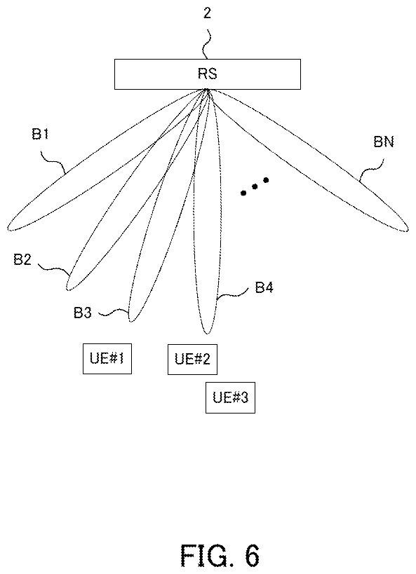

As illustrated in FIG. 6, the relay station 2 can form a plurality of beams B1 to BN. The beam corresponds to a transmission beam for transmitting a radio signal and/or a reception beam for receiving a radio signal. In addition, the relay station 2 includes a plurality of antenna elements to implement MIMO communication. Then, the relay station 2 can form a transmission beam by controlling a weight by which a signal transmitted via each antenna element is to be multiplied and can form a reception beam by controlling a weight by which a signal received via each antenna element is to be multiplied. Note that the plurality of beams B1 to BN are preferably configured uniformly.

The beam estimator 21 estimates a beam associated with the user terminal 3 among the plurality of beams B1 to BN based on a relative position of the user terminal 3 with respect to the relay station 2. In the embodiment illustrated in FIG. 6, the beam estimator 21 estimates that the beam B3, the beam B4, and the beam B4 are associated with the UE #1, the UE #2, and the UE #3, respectively. In this manner, one beam is associated with each user terminal 3. In this event, the same beam may be associated with a plurality of user terminals 3.

For each user terminal 3, the received power estimator 22 estimates the received power of the signal received from the corresponding user terminal by the relay station 2 using the beam associated with the target user terminal. The target user terminal represents any one user terminal among the user terminals located in the cell of the relay station 2. For example, in the embodiment illustrated in FIG. 6, it is assumed that the UE #1 is the target user terminal. Here, the UE #1 is associated with the beam B3. Thus, in this case, the received power of signals received from the UE #1 to the UE #3 by the relay station 2 using the beam B3 is estimated.

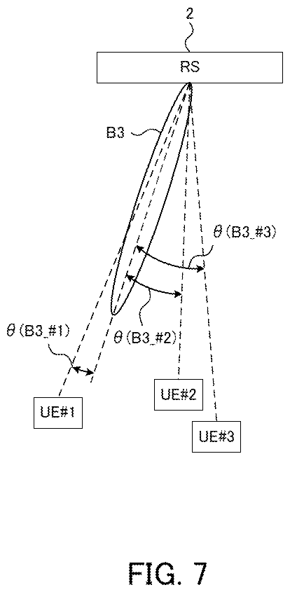

The received power depends on a distance between the relay station 2 and the user terminal 3 and a relative direction of the user terminal 3 with respect to the relay station 2. For example, in the case illustrated in FIG. 7, the UE #1 is the target user terminal. Then, the power of the signals received from the UE #1 to the UE #3 by the relay station 2 using the beam B3 is estimated. In this case, the received power corresponding to the UE #1 is calculated based on a distance between the relay station 2 and the UE #1 and an angle θ (B3_#1) between the beam B3 and a relative direction of the UE 1l with respect to the relay station 2. The received power corresponding to the UE #2 is calculated based on a distance between the relay station 2 and the UE #2 and an angle θ (B3_#2) between the beam B3 and a relative direction of the UE #2 with respect to the relay station 2. The received power corresponding to the UE #3 is calculated based on a distance between the relay station 2 and the UE #3 and an angle θ (B3_#3) between the beam B3 and a relative direction of the UE #3 with respect to the relay station 2.

The received power estimator 22 estimates received power while sequentially selecting the target user terminal one by one. In other words, in the case illustrated in FIG. 6, the received power corresponding to the UE #1 to the UE #3 when the UE #1 is the target user terminal, the received power corresponding to the UE #1 to the UE #3 when the UE #2 is the target user terminal, and the received power corresponding to the UE #1 to the UE #3 when the UE #3 is the target user terminal are estimated.

The selection probability determination unit 23 determines a selection probability indicating a probability that each user terminal is selected and a simultaneous selection probability indicating a probability that the other user terminal is simultaneously selected when the target user terminal is selected. In this event, the selection probability determination unit 23 determines the selection probability and the simultaneous selection probability based on a selection policy for selecting the user terminal in spatial multiplexing. The selection policy is, for example, “fair” or “equal”.

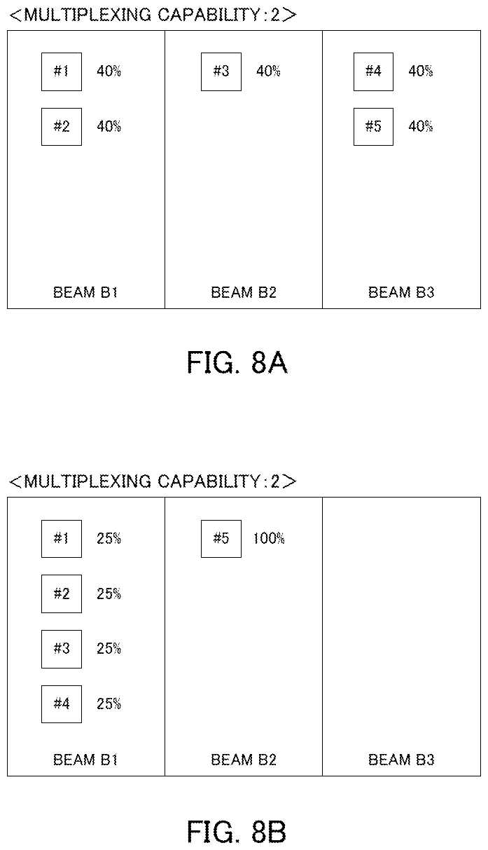

An example will be described. Here, as illustrated in FIG. 8A, the relay station 2 can configure three beams B1 to B3. The relay station 2 can simultaneously communicate with two user terminals 3 by spatial multiplexing. In other words, the multiplexing capability of the relay stations 2 is two. Five user terminals (UE #1 to UE #5) are located in a cell of the relay station 2. Specifically, the UE #1 and the UE #2 are located in a direction of the beam B1, the UE #3 is located in a direction of the beam B2, and the UE #4 and the UE #5 are located in a direction of the beam B3. However, it is assumed that the relay station 2 can communicate with only one user terminal using one beam.

The selection probability of each user terminal is calculated by evenly distributing resources corresponding to the multiplexing capability of the relay station 2 to each user terminal. In other words, when the relay station 2 is configured to be able to simultaneously communicate with N user terminals, the selection probability of each user terminal is determined by evenly distributing “N×100%” to a plurality of user terminals. In this embodiment, the multiplexing capability of the relay station 2 is two. Thus, “200%” is evenly distributed to the five user terminals. Specifically, “200%” is evenly distributed to the UE #1 to the UE #5. In other words, the selection probabilities of the UE #1 to the UE #5 are “40%”.

In the case illustrated in FIG. BB, the UE #1 to the UE #4 are associated with the beam B1, and the UE #5 is associated with the beam B2. In this case, if “200%” is evenly distributed to the UE #1 to the UE #5, a sum of the selection probabilities of the user terminal (UE #1 to UE #4) associated with the beam B1 is 160%, which exceeds 100%. However, in this embodiment, the number of user terminals with which the relay station 2 can communicate using one beam is “1”. Here, a state in which the sum of the selection probabilities of the user terminal associated with one beam exceeds 100% corresponds to a state in which a plurality of user terminals are connected to the relay station 2 using one beam. Thus, the selection probability determination unit 23 determines the selection probabilities of the user terminal so that the sum of the selection probabilities of the user terminal associated with one beam does not exceed “100%”.

In this example, four user terminals (that is, UE #1 to UE #4) are associated with the beam B1, the selection probabilities of the UE #1 to the UE #4 are determined by evenly distributing “100%” to the UE #1 to the UE #4. Thus, the selection probabilities of the UE #1 to the UE #4 are “25%”. In addition, the remaining resources are distributed to the other user terminal (that is, the UE #5). In other words, “100%” is distributed to the UE #5. Thus, the selection probability of the UE #5 is “100%”.

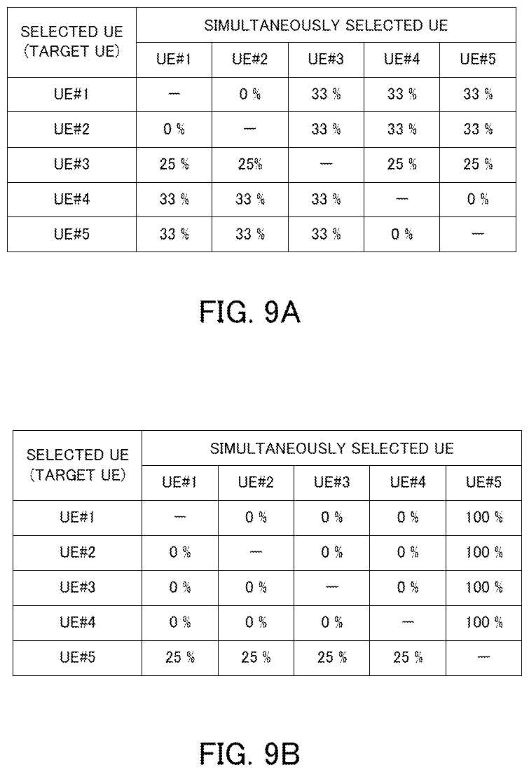

Next, the selection probability determination unit 23 determines the simultaneous selection probability of each user terminal 3. In other words, the probability that the other user terminal is simultaneously selected when the target user terminal is selected is determined. Here, as an example, the simultaneous selection probability of each user terminal is calculated in the case illustrated in FIG. BA. The calculation result is as illustrated in FIG. 9A.

In the case illustrated in FIG. BA, when the relay station 2 selects the UE #1 (that is, when the UE #1 is the target user terminal), the beam B1 is occupied by the UE #1. Thus, when the UE #1 is selected, the probability that the other user terminal associated with the beam B1 is selected is zero. Specifically, a probability that the UE #2 is simultaneously selected when the UE #1 is selected is zero.

When the relay station 2 selects the UE #1, the probability that the user terminal (hereinafter, “other beam UE”) associated with other beams (that is, beams B2 and B3) are simultaneously selected is calculated by distributing the remaining resources to the other beam UE according to the selection probability of the other beam UE. Here, in a case where the relay station 2 is configured to be able to communicate with N user terminals at the same time, the resources remaining after the target user terminal is selected correspond to “(N−1)×100%”. Thus, the simultaneous selection probability of the other beam UE is determined by distributing “(N−1)×100%” to the other beam UE according to the selection probability of the other beam UE. In this example, the multiplexing capability is two. Thus, “100%” is distributed to the other beam UE. In addition, in this example, the user terminal associated with other beams (that is, beams B2 and B3) is the UE #3 to the UE #5. Further, the selection probabilities of the UE #3 to the UE #5 are the same as each other as illustrated in FIG. 8A. Thus, the probability that the UE #3 to the UE #5 are simultaneously selected when UE #1 is selected is obtained by evenly distributing “100%” to the UE #3 to the UE #5. In other words, the simultaneous selection probabilities of the UE #3 to the UE #5 are 33%. Note that the probability that the other user terminal is simultaneously selected when the UE #2, the UE #4, or the UE #5 is selected can be considered similar to that when the UE #1 is selected.

When the relay station 2 selects the UE #3 (that is, when the UE #3 is the target user terminal), the remaining resources (that is, 100%) are distributed to the other beam UE (that is, UE #1, UE #2, UE #4, and UE #5). Here, the selection probabilities of the UE #1, the UE #2, the UE #4, and the UE #5 are the same as each other as illustrated in FIG. 8A. Thus, the probability that the UE #1, the UE #2, the UE #4, and the UE #5 are simultaneously selected when the UE #3 is selected is obtained by evenly distributing “100%” to the UE #1, the UE #2, the UE #4, and the UE #5. In other words, the simultaneous selection probabilities of the UE #1, the UE #2, the UE #4, and the UE #5 are 25%.

Furthermore, in the case illustrated in FIG. 8B, the probability of simultaneous selection of the other user terminal when the target user terminal is selected is as illustrated in FIG. 9B. Specifically, when the relay station 2 selects the UE #1 (that is, when the UE #1 is the target user terminal), the beam B1 is occupied by the UE #1. Thus, a probability that the UE #2 to the UE #4 are simultaneously selected when the UE #1 is selected is zero.

When the relay station 2 selects the UE #1, the user terminal (that is, the other beam UE) associated with other beams (that is, beams B2 and B3) is only the UE #5. In this case, the resources remaining after selecting the target user terminal are all distributed to the UE #5. Thus, the probability that the UE #5 is simultaneously selected when the relay station 2 selects the UE #1 is 100%. Note that the probability that the other user terminal is simultaneously selected when the UE #2, the UE #3, or the UE #4 is selected can be considered similar to that when the UE #1 is selected.

When the relay station 2 selects the UE #5 (that is, when the UE #5 is the target user terminal), the remaining resources are distributed to the other beam UE (that is, the UE #1 to the UE #4). Here, the selection probabilities of the UE #1 to the UE #4 are the same as each other as illustrated in FIG. 8B. Thus, the probability that the UE #1, the UE #2, the UE #3, and the UE #4 are simultaneously selected when the UE #5 is selected is obtained by evenly distributing “100%” to the UE #1, the UE #2, the UE #3, and the UE #4. In other words, the simultaneous selection probabilities of the UE #1, the UE #2, the UE #3, and the UE #4 are 25%.

The interference power estimator 24 estimates average interference power for a signal transmitted from the target user terminal. In this event, the average interference power for the signal transmitted from the target user terminal is estimated based on the received power corresponding to each user terminal other than the target user terminal and the simultaneous selection probability of each user terminal other than the target user terminal.

For example, average interference power Iu for the signal transmitted from UE #u is expressed by Formula (1).

Īᵤ=Σ_{e≠u}α_{u,w}·P_{u,w} (1)

u identifies arbitrary user terminal (that is, the target user terminal) among the user terminals located in the cell of the relay station 2. w identifies the other user terminal among the user terminals located in the cell of the relay station 2. α_{u,w} represents a probability that UE #w is simultaneously selected when the UE #u is selected. P_{u,w} represents power of a signal received from the UE #w by the relay station 2 using a beam associated with the UE #u.

The interference power estimator 24 estimates average interference power for a signal transmitted from each user terminal by using Formula (1). Here, the average interference power is estimated in the cases illustrated in FIGS. 8B and 9B.

For example, the average interference power for the signal transmitted from the UE #1 is expressed by Formula (2). Here, P_{1,5} represents power of a signal received from the UE #5 by the relay station 2 using a beam (in examples, beam B1) associated with the UE #1. Note that, the probability that the UE #2 to the UE #4 are simultaneously selected when the UE #1 is selected is zero, and thus, it is not necessary to consider received power corresponding to the UE #2 to the UE #4.

Ī₁=100/100×P_{1,5} (2)

The average interference power for the signal transmitted from the UE #5 is expressed by Formula (3). In Formula (3), P_{5,1}, P_{5,2}, P_{5,3}, and P_{5,4} respectively represent the power of the signals received from the UE #1, the UE #2, the UE #3, and the UE #4 using the beam (in examples, beam B2) associated with the UE #5 by the relay station 2.

Ī₅=25/100×P_{5,1}+25/100×P_{5,2}+25/100×P_{5,3}+25/100×P_{5,4} (3)

The transmission rate estimator 25 estimates the average transmission rate between the relay station 2 and the target user terminal based on the received power corresponding to the target user terminal, the average interference power with respect to the signal transmitted from the target user terminal, and the selection probability of the target user terminal. Specifically, the transmission rate estimator 25 first calculates an average signal to interference plus noise ratio (SINR) of the signal transmitted from the target user terminal based on the received power corresponding to the target user terminal and the average interference power with respect to the signal transmitted from the target user terminal. Here, the average SINR is represented by Formula (4).

$${\overline{SINR R}}_{u} = \frac{{P}_{u , u}}{{σ}^{2} + β {\overline{I}}_{u}} \qquad ( 4 )$$

P_{u,u} represents received power corresponding to the target user terminal. In other words, P_{u,u} represents power of a signal received from the UE #u by the relay station 2 using a beam associated with the UE #u. A square of σ represents noise power. Note that the noise power is assumed to be obtained in advance by simulation, measurement, or the like. β represents an interference suppression coefficient and is a real number greater than 0 and less than 1. Here, it is assumed that the relay station 2 has an interference suppression function of suppressing an interference component in order to extract a target signal from a signal received using a reception beam. Then, an interference suppression coefficient β is determined in advance by simulation, or the like, based on performance of the relay station 2. In this case, the performance of the relay station 2 depends on hardware performance of the relay station 2 and an interference suppression calculation algorithm to be used by the relay station 2.

Subsequently, the transmission rate estimator 25 estimates the average transmission rate between the relay station 2 and the target user terminal based on the average SINR and the selection probability of the target user terminal. Specifically, an average transmission rate Ru between the relay station 2 and the UE #u is expressed by Formula (5). αᵤ represents a probability that the UE #u (that is, the target user terminal) is selected.

Ru=αᵤ log₂(1+S̅I̅N̅R̅ᵤ) (5)

The transmission rate estimator 25 estimates an average transmission rate between the relay station 2 and each user terminal. In the example illustrated in FIGS. 8A, 8B, 9A, and 9B, an average transmission rate is estimated for each of the UE #1 to the UE #5. Then, the transmission rate estimator 25 calculates an average of the average transmission rates of the user terminal. As a result, an average transmission rate between the relay station 2 and the user terminal for one candidate for the destination is obtained. Further, the transmission rate estimator 25 calculates an average transmission rate for each of the plurality of candidates for the destination.

Thereafter, the destination determination unit 14 illustrated in FIG. 4 selects a candidate for the destination having the highest average transmission rate from the plurality of candidates for the destination. In other words, the destination of the relay station 2 is determined. Then, the relay station controller 15 generates an instruction to move the relay station 2 to the destination determined by the destination determination unit 14. As a result, the relay station 2 is disposed at a position where the average transmission rate is expected to be high. This results in improving performance of the radio communication system 100.

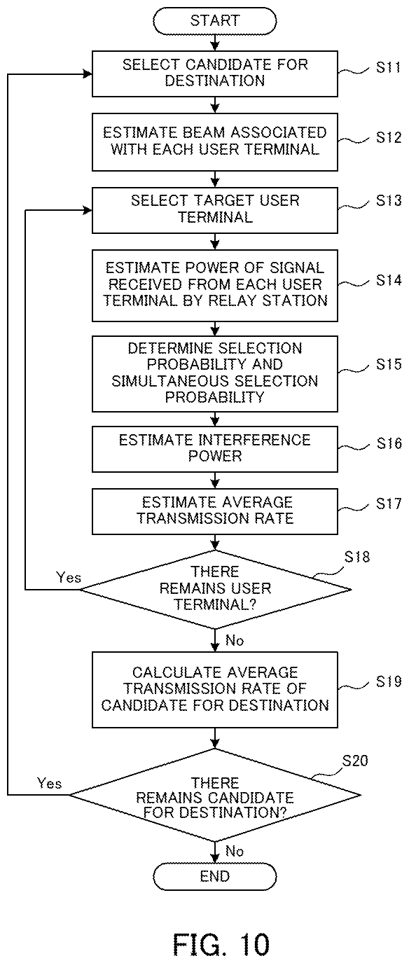

FIG. 10 is a flowchart illustrating an example of a process of estimating an average transmission rate. This process corresponds to S2 of the flowchart illustrated in FIG. 5.

In S11, the estimator 13 selects a candidate for the destination for which the average transmission rate is to be estimated from the plurality of candidates for the destination. Thereafter, the estimator 13 executes the processing of S12 to S19 assuming that the relay station 2 is located in the selected candidate for the destination.

In S12, the beam estimator 21 estimates a beam associated with each of the plurality of user terminals located in the cell of the relay station 2 by the relay station 2. In S13, the estimator 13 selects the target user terminal from the plurality of user terminals located in the cell of the relay station 2. Thereafter, the estimator 13 executes the processing of S14 to S17 on the target user terminal.

In S14, the received power estimator 22 estimates the received power of the signal received from the corresponding user terminal by the relay station 2 using the target beam associated with the target user terminal. In S15, the selection probability determination unit 23 determines the probability that the target user terminal is selected and the probability that each of other user terminals is simultaneously selected when the target user terminal is selected based on a specified selection policy. In S16, the interference power estimator 24 estimates the average interference power for the signal transmitted from the target user terminal based on the received power corresponding to each user terminal and the simultaneous selection probability of each user terminal. In S17, the transmission rate estimator 25 estimates the average transmission rate between the relay station 2 and the target user terminal based on the received power corresponding to the target user terminal, the average interference power with respect to the signal transmitted from the target user terminal, and the selection probability of the target user terminal. In other words, weighted average based on the selection probability of each user terminal is performed.

In S18, the estimator 13 determines whether the average transmission rate has been estimated for all the user terminal. If there remains a user terminal for which the average transmission rate has not been estimated, the process of the estimator 13 returns to S13. When the average transmission rate has been estimated for all the user terminal, the transmission rate estimator 25 calculates the average transmission rate of the candidate for the destination by calculating the average of the average transmission rates of the user terminal.

In S20, the estimator 13 determines whether the average transmission rate has been estimated for all the candidates for the destination. If there remains a candidate for the destination for which the average transmission rate has not been estimated, the process of the estimator 13 returns to S11. Then, when the average transmission rate has been estimated for all the candidates for the destination, the process of the estimator 13 ends. In this manner, the estimator 13 executes the process of S14 to S17 for each candidate for the destination the same number of times as the number of user terminals located in the cell of the relay station 2.

Note that the radio communication control device 10 is implemented by, for example, a microcomputer including a processor and a memory. In this case, a control program describing the process of the flowchart illustrated in FIG. 5 is stored in the memory. Then, the processor executes the control program to provide functions of the position information acquiring unit 11, the destination candidate manager 12, the estimator 13, the destination determination unit 14, and the relay station controller 15 illustrated in FIG. 4. Alternatively, a transmission rate estimation program describing the process of the flowchart illustrated in FIG. 10 is stored in the memory. Then, the processor executes the transmission rate estimation program to provide functions of the beam estimator 21, the received power estimator 22, the selection probability determination unit 23, the interference power estimator 24, and the transmission rate estimator 25 illustrated in FIG. 4.

Simulation

In order to confirm an effect of the transmission rate estimation method according to the embodiment of the present disclosure, the embodiment of the present disclosure is compared with all-pattern selection method. In the all-pattern selection method, transmission rates are estimated for all selection patterns of the user terminal and then an average thereof is calculated. Note that in the all-pattern selection method, estimation accuracy of the transmission rate is high, but a calculation amount is enormous. For example, when the multiplexing capability of the relay station 2 is 4 and ten user terminals 3 are located in the cell of the relay station 2, it is necessary to perform 840 patterns of transmission rate estimation. On the other hand, in the embodiment of the present disclosure, for estimating the transmission rate, the number of times of calculation is the same as the number of user terminals 3 located in the cell of the relay station 2.

The simulation conditions are as follows.
(1) The number of relay stations is three.
(2) The relay station can simultaneously communicate with four user terminals by spatial multiplexing (multiplexing capability: 4).
(3) A frequency is 28 GHz and a bandwidth is 400 MHz.
(4) An antenna configuration of the relay station is 8 elements×8 elements (0.5λ spacing).
(5) A coverage area of relay station is −60 degrees to +60 degrees, 60 to 100 m
(6) 18 user terminals are uniformly distributed in the cell of the relay station.
(7) The relay station is disposed at a height of 30 m, and the user terminal is disposed at a height of 1.5 m.
(8) The user terminal has maximum transmission power of 23 dBm and performs TPC with a target SNR of 30 dB.
(9) A pathloss model is based on 3GPP UMi Street Canyon (LOS).
(10) Throughput is calculated based on Shannon channel capacity.
(11) Digital beamforming is performed through MMSE

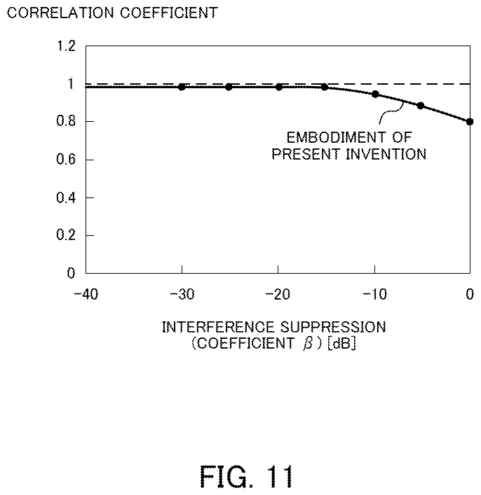

FIG. 11 illustrates a result of simulation relating to comparison between the embodiment of the present disclosure and the all-pattern selection method. In FIG. 11, a broken line represents a reference level. The reference level represents a state in which the transmission rate is estimated by the all-pattern selection method. A solid line represents a state in which the transmission rate is estimated in the embodiment of the present disclosure. A vertical axis represents correlation between the reference level and the embodiment of the present disclosure. A horizontal axis corresponds to the interference suppression coefficient β to be used in the embodiment of the present disclosure.

According to this simulation, when the interference suppression coefficient β is appropriately determined, the correlation coefficient becomes substantially 1. In other words, if the interference suppression coefficient β is appropriately determined, the transmission rate estimated by the method according to the embodiment of the present disclosure substantially matches the transmission rate estimated by the all-pattern selection method. Thus, according to the embodiment of the present disclosure, the transmission rate can be accurately estimated with a small calculation amount. As a result, the relay station 2 is disposed at an appropriate position, so that quality of the radio communication system 100 is improved.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

What is claimed is:

1. A radio communication control device comprising:
a processor that executes instructions to:
estimate beams that are respectively associated with a plurality of user terminals located in a cell of a communication device that supports spatial multiplexing;
estimate, for each of the plurality of user terminals, received power of a signal received by the communication device from a corresponding user terminal by using a target beam associated with a target user terminal among the plurality of user terminals;
determine a selection probability indicating a probability that the target user terminal is selected and a simultaneous selection probability indicating a probability that each of the other user terminal among the plurality of user terminals is selected when the target user terminal is selected based on a selection policy determined in advance for selecting a user terminal in the spatial multiplexing;
estimate average interference power for a signal transmitted from the target user terminal based on received power corresponding to each of the other user terminal and a simultaneous selection probability of each of the other user terminal; and
estimate an average transmission rate between the communication device and the target user terminal based on received power corresponding to the target user terminal, the average interference power, and the selection probability of the target user terminal.

2. The radio communication control device according to claim 1, wherein
the selection probability of each user terminal is determined by evenly distributing resources corresponding to the number of user terminals that the communication device is able to simultaneously communicate, to the plurality of user terminals.

3. The radio communication control device according to claim 1, wherein
when the communication device is configured to be able to simultaneously communicate with N user terminals, the selection probability of each user terminal is determined by evenly distributing N×100% to the plurality of user terminals.

4. The radio communication control device according to claim 3, wherein
the selection probability of each user terminal is determined such that a sum of the selection probabilities of the user terminal associated with one beam does not exceed 100%.

5. The radio communication control device according to claim 3, wherein
the simultaneous selection probability of each of the other user terminal is determined by distributing (N−1)×100% according to selection probabilities corresponding to a user terminal associated with beams other than the target beam.

6. The radio communication control device according to claim 1, wherein
the processor estimates an average transmission rate between the communication device and the target user terminal by multiplying a transmission rate obtained based on the received power corresponding to the target user terminal and the average interference power by the selection probability of the target user terminal.

7. The radio communication control device according to claim 1, wherein
the processor
calculates second average interference power by multiplying the estimated average interference power by an interference suppression coefficient which is greater than 0 and less than 1 and which is determined based on interference suppression performance of the communication device, and
estimates an average transmission rate between the communication device and the target user terminal based on the received power corresponding to the target user terminal, the second average interference power, and the selection probability of the target user terminal.

8. The radio communication control device according to claim 1, wherein
the processor
sequentially selects the target user terminal one by one from the plurality of user terminals and estimates an average transmission rate of each of the selected target user terminal, and
calculates an average of estimated average transmission rates for the plurality of user terminals to obtain a second average transmission rate.

9. The radio communication control device according to claim 8, wherein
the processor calculates the second average transmission rate for each of the plurality of candidates for the destination of the communication device,
the processor selects a candidate for the destination having the highest second average transmission rate from the plurality of candidates for the destination, and
the processor moves the communication device to a position corresponding to the selected candidate for the destination.

10. A radio communication control method comprising:
estimating beams that are respectively associated with a plurality of user terminals located in a cell of a communication device that supports spatial multiplexing;
estimating, for each of the plurality of user terminals, received power of a signal received by the communication device from a corresponding user terminal by using a target beam associated with a target user terminal among the plurality of user terminals;
determining a selection probability indicating a probability that the target user terminal is selected and a simultaneous selection probability indicating a probability that each of the other user terminal among the plurality of user terminals is selected when the target user terminal is selected based on a selection policy determined in advance for selecting a user terminal in the spatial multiplexing;
estimating average interference power for a signal transmitted from the target user terminal based on received power corresponding to each of the other user terminal and a simultaneous selection probability of each of the other user terminal; and
estimating an average transmission rate between the communication device and the target user terminal based on received power corresponding to the target user terminal, the average interference power, and the selection probability of the target user terminal.

11. A computer-readable non-transitory recording medium having stored therein a transmission rate estimation program for causing a computer to execute a transmission rate estimation process, the process comprising:
estimating beams that are respectively associated with a plurality of user terminals located in a cell of a communication device that supports spatial multiplexing;
estimating, for each of the plurality of user terminals, received power of a signal received by the communication device from a corresponding user terminal by using a target beam associated with a target user terminal among the plurality of user terminals;
determining a selection probability indicating a probability that the target user terminal is selected and a simultaneous selection probability indicating a probability that each of the other user terminal among the plurality of user terminals is selected when the target user terminal is selected based on a selection policy determined in advance for selecting a user terminal in the spatial multiplexing;
estimating average interference power for a signal transmitted from the target user terminal based on received power corresponding to each of the other user terminal and a simultaneous selection probability of each of the other user terminal; and
estimating an average transmission rate between the communication device and the target user terminal based on received power corresponding to the target user terminal, the average interference power, and the selection probability of the target user terminal.
